(19) United States
(12) Patent Application Publication
(10) Pub. No.: US 2019/0028911 A1
(43) Pub. Date: Jan. 24, 2019

(54) DEVICE FOR GENERATING A DATABASE

(71) Applicant: UNIVERSITÄT ROSTOCK, Rostock (DE)

(72) Inventor: Till WOLLENBERG, Rostock (DE)

(73) Assignee: VESTIFI GMBH, Rostock (DE)

(21) Appl. No.: 16/060,569

(22) PCT Filed: Dec. 8, 2016
(86) PCT No.: PCT/EP2016/080299

§ 371 Date: Oct. 1, 2018

(30) Foreign Application Priority Data
Dec. 10, 2015 (DE) 10 2015 121 488.1

(51) Int. Cl. H04W 24/08; G06F 17/30; H04L 12/26

(52) U.S. Cl. CPC H04W 24/08; H04W 84/12; H04L 43/024; G06F 17/30312

(57) ABSTRACT

Devices and methods generate at least one database suitable for identifying problems in a wireless network. The devices and methods comprise at least one receiver unit for receiving data packets via a radio channel of the wireless network and a memory unit for storing data from received data packets. The devices and methods also comprise a control unit designed to store only control data contained in the received data packets in the memory unit. Thereby, the control unit is designed to dynamically select data packets received independently from the receiver unit for storage in the database.

The present invention relates to a device for generating a database. The database is suitable for identifying problems in a wireless network.

### TECHNICAL BACKGROUND

In the corporate environment, wireless local area networks (WLANs) or other radio-based networks are omnipresent in many industries today. While a few years ago, however, non-critical areas of application such as “Internet access for visitors” prevailed, wireless network access is increasingly being used in more critical areas. In modern office forms without permanently assigned workplaces, work equipment is usually integrated into the company network, e.g. via WLAN. This also applies to cordless IP telephones (voice-over-IP) and mobile data acquisition devices (for example bar code scanners). Some devices, such as particularly compact notebooks or tablet PCs, no longer have a wired network interface.

Errors in WLAN network operation are not only annoying in business operations but disturb the business operations and thus lead to real costs regularly. The causes of the errors must therefore be found quickly and remedied at short notice.

Disturbances or problems often only occur locally (for example, poor radio coverage, locally effective source of interference, space with many simultaneous active WLAN devices). A diagnosis of such problems therefore usually requires a measurement at the very place where the problems occur. The causes are as varied as the error patterns: Possible causes are, for example, configuration errors in terminals and/or infrastructure, hardware problems, software errors, incorrect planning, overload of the network, use of unauthorized WLAN devices, interference from neighboring WLAN systems, from other radio services in the same frequency range and/or from interference radiation from machines and devices.

Many errors in the WLAN supply usually do not occur permanently, but only temporarily or sporadically. In addition, the problems often cannot be reliably reproduced. Furthermore, it is generally helpful to consider larger time ranges for the recognition of correlations.

Depending on the measurement method and the intensity of WLAN usage, extensive data is generated during the measurement. In order to be able to measure over longer periods of time (for example several days) or permanently, a data connection is then required via which the measurement data can be transported away during the measurement. In this case, for example, a central server is required to record the measurement data.

The dependence of the measurement on the availability of a wired network connection limits the choice of the measurement location and is generally not possible in certain situations (for example closed areas, moving machines, etc.). Connecting the measuring device by radio is problematic because it influences the measurement and, in addition to that, areas with insufficient radio network coverage are more frequently the subject of a measurement.

US 2005/0128989 A1 describes a method and system for monitoring a selected region of airspace associated with a local area network of computer devices. US 2007/0180106 A1 deals with performance prediction of media streams over wireless networks and teaches to determine and identify artifacts introduced by transmission by comparing an uncompressed transmitted benchmark workload with a compressed transmitted version of the benchmark workload. PAN, J.-Y.: “FASTCARS: fast, correlation-aware sampling for network data mining”, In: Research Showcase @ CMU, pp. 1-25, 2002, describes the acquisition of correlation between successive and spaced packets for traffic sampling. Further state of the art is described in US 2007/0088981 A1, US 2005/0227625 A1, US 2006/0023838 A1 and US 2010/0296496 A1.

### Invention

According to the invention, a device according to claim 1 is proposed which is designed to generate a data basis suitable for an identification of problems in a wireless network, for example only temporarily, sporadically and/or not reproducibly occurring problems. Advantageous embodiments of the device according to the invention are specified in the dependent claims. According to the invention, a method according to claim 10 for identifying problems in a wireless network is also proposed.

A control unit is designed to select data packets received from the receiver unit (EE) for storage in the database independently, i.e. automatically and dynamically adaptively. This enables the intelligent storage of relevant data packages and consequently storage of data from significantly longer periods of time and thus a higher probability that problems that occur only temporarily, sporadically and/or not reproducibly can be identified, diagnosed and/or localized based on the stored data.

The proposed method allows also inexperienced users to cost-effectively obtain a database for identifying problems in a wireless network.

### DESCRIPTION OF FIGURES

FIG. 1 shows an exemplary embodiment of the invention.

### EMBODIMENTS

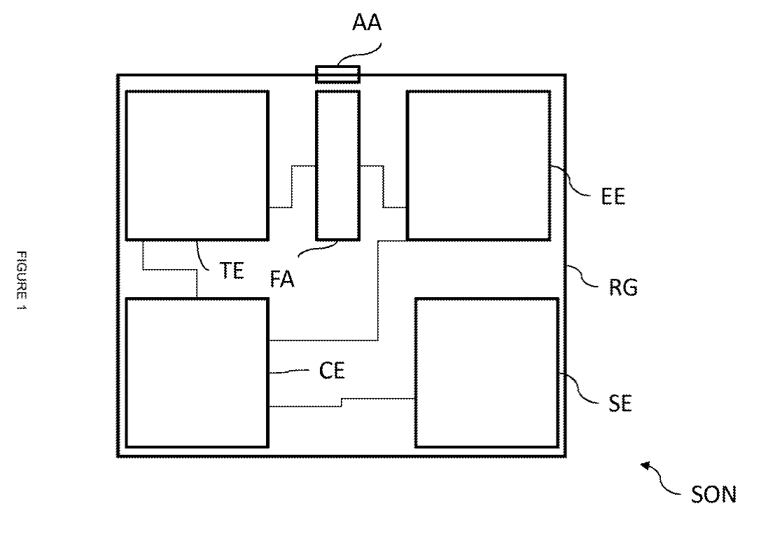

FIG. 1 shows an exemplary embodiment of the invention.

In the exemplary embodiment shown, the device SON comprises at least one receiver unit EE for receiving data packets via a radio channel of the wireless network and a memory unit SE for storing data from received data packets.

The stored data can be data from one or more layers under a media access control layer (MAC layer) or a logical link control layer (LLC layer). For example, data from the bit transfer layer is stored. For example, data on signal level, modulation method and/or bandwidth are stored.

Furthermore, the device comprises a control unit CE, which is designed to store only control data contained in the received data packets in the memory unit SE. In this case, only a part of the control data of a subsequently received data packet is stored which is not correlated with the control data of a previously received data packet.

For example, in the case of regularly repeated control messages, only the variable part is stored.

Elements that are not relevant for the evaluation can also be excluded in both useful and control data. An entropy coding of all recorded data is also possible. Even before recording, less relevant data for the evaluation of a target network can be discarded. These may include transmissions from other networks or transmissions from clients that do not connect to the target network. In some exemplary embodiments, however, meta information from the less relevant data packets are retained, for example if a transmission on one channel at a time occupies the channel for a period of time, even if the transmission was not carried out by the target network or was not used to connect to the target network.

The device SON is configured in exemplary embodiments of the invention to make decisions independently, i.e. in an automated and dynamically adaptive manner. For example, the device SON may be configured to learn relevance from clients, depending on whether and how often they connect to the target network, and/or whether a problem correlates with activities of the client.

The control unit CE of the exemplary embodiment shown is designed to dynamically select data packets received via the receiver unit EE for storage in the memory unit SE as part of a data basis for identification of network problems. The dynamics take into account, for example, a radio channel load, a disturbance to be examined and/or an available data storage capacity.

The control unit CE of the exemplary embodiment shown is also designed to control the receiver unit EE in such a way that it receives data packets in chronological order via the at least two radio channels in order to be able to monitor more than one radio channel without having to keep a corresponding number of receiver units available. The control unit CE controls the receiver unit EE dynamically to change channels, whereby the dynamics take into account, for example, a load on the radio channels, a disturbance to be examined and/or an available data storage capacity.

In an exemplary embodiment, the receiver unit EE first switches from channel to channel according to a predetermined initial pattern with the same dwell time on each channel. The rate and/or type of use, load and/or disturbance observed within the initial pattern causes a change in the pattern, so that an improvement in the quality of the measured data compared to the initial pattern [develops/results].

For example, in a completely unknown situation, all technically possible channels can initially be observed the same number of times. The data obtained in this way are still evaluated automatically in the probe. As a result, channels are observed more frequently/longer, which are, for example, heavily loaded, used by many base stations, used by many clients, have many disturbances or problems, which are used by relevant networks (e.g. via preconfigured names of customer networks or preconfigured device addresses of known customer devices) or which are used by devices in the local vicinity of the measuring device. Since the measurement situation (also: measurement position) can change during the course of the measurement, while adjustment the measurement parameters must be continuously checked and, if necessary, repeatedly adjusted.

The control unit CE of the exemplary embodiment shown is designed to control the receiver unit EE in such a way that a number of data packets received via one of the respective channels is proportional to a load of the respective channel.

The device SON shown also comprises a transmitter unit TE for sending test data packets via one radio channel of the wireless network, but the transmitter unit is optional. For example, in order to measure a quality of the radio network and/or parameters which cannot be determined currently or in principle by observing already existing radio activity or for other purposes, the control unit CE is designed to control the transmitting unit TE so that these test data packets transmit at times which are determined by the control unit CE depending on a load of the radio channel, an additional load of the radio channel by test data packets and/or a disturbance of the radio channel by the test data packets. However, neither the transmitter unit TE nor the associated configuration of the control unit CE are essential for the present invention.

The control unit CE and the receiver unit TE of the exemplary embodiment are integrated in a robust housing RG. The robust housing RG is weatherproof, vibration-proof and/or impact-proof. Additionally or alternatively, device SON can be designed temperature resistant. However, the robust housing RG is not essential for this invention. The illustrated device SON furthermore comprises at least one radio antenna FA integrated in the robust housing RG and at least one connection AA on the housing RG for connecting an external radio antenna. However, these are not essential to the present invention.

The device SON shown further comprises at least one radio antenna FA also integrated in the robust housing RG and at least one connection AA on the housing RG for connecting an external radio antenna. However, these are not essential for the present invention.

The device SON shown further comprises a unit SP for the acquisition of measurement data for the use of the frequency spectrum. During this process, the measurement data are stored. However, this is not essential for the present invention.

Since interferences are also caused by other radio systems, an analysis of the measurement data for the use of the frequency spectrum is useful, as any kind of radio activity can be detected in the relevant frequency range.

The measurement data can be acquired with different time resolutions and/or with different frequency resolutions and/or with different recording delays and/or with measuring principles. Therefore, the control unit CE of the design example shown is designed to control the measurement data acquisition in such a way that the measurement data are synchronized with one another and/or with the control data. However, this is not essential for this invention.

The control unit CE of the exemplary embodiment shown is further designed to mask artifacts in the measurement data, wherein the artifacts are artifacts generated by the device and/or by one or more further devices specified in the control device with respect to their artifacts.

The device SON may also include a real-time clock; a satellite-based positioning system; a secondary battery; a power connection and/or—an external memory port for connecting an external memory unit.

Another exemplary embodiment of this invention is a device, also referred to below as an “independent WLAN measuring probe”, i.e. a measuring device that can receive WLAN radio traffic at the level of the air interface in at least one radio channel by means of at least one corresponding receiver unit. Data from received data packets are stored on a storage medium within the independent WLAN measuring probe. The data can then be read out at a later time and evaluated in a separate system, for example. Reception and storage are controlled by a control unit of the independent WLAN measuring probe. The independent WLAN measuring probe can also acquire additional measurement data with the aid of a spectrum analyzer, but this is not essential for the present invention.

A special feature of the further exemplary embodiment is therefore the independent operation without connection to an external storage, monitoring or control system. Preferably—but not necessarily—the independent WLAN measuring probe is also energy independent, at least for bridging periods, e.g. by means of a comprised battery.

The independent WLAN measuring probe is configured to filter measurement data already during recording and to compress the filtered data loss-free. The filtering is carried out in a way that does not affect a subsequent evaluation—Irrespective of the details relevant for the subsequent evaluation. For example, only control data from received data packages are stored in delta-coded form. In this process, a control unit of the independent WLAN measuring probe compares control data of a subsequently received data packet with control data of a previously received data packet and determines the uncorrelated part of the control data of a subsequently received data packet. The uncorrelated part is then stored.

For example, the independent WLAN measurement probe can be configured to select the radio channels to be monitored automatically, and optionally dynamically. This may also include a selection of a suitable channel hopping pattern when a number of receiving units comprised by the independent WLAN probe is less than a number of channels to be observed.

The control unit of the independent WLAN measuring probe can also be configured for active teats. Than the control unit of the independent WLAN measuring probe is configured to automatically acquire times for the active tests and to arrange and/or execute the active tests in such a way that the observed WLAN system is not overloaded or disturbed by the tests.

To ensure the coherence of measurement data from different, mutually affecting sources, the control unit of the independent WLAN measuring probe can furthermore be configured to synchronize measurement data from different sources with different time and frequency resolution as well as different recording delays and measurement principles and/or to detect and mask artifacts caused by the independent WLAN measuring probe itself.

In the following, a specific, exemplary embodiment of the independent WLAN measuring probe is described.

In the specific, exemplary embodiment, the independent WLAN measuring probe has measurement capabilities that enable the reception and recording of WLAN data traffic at the level of the air interface. In this way, any WLAN communication that can be received at the location of the independent WLAN measuring probe can be analyzed. The receiver units can be realized by modules, so that the independent WLAN measuring probe can be converted when new WLAN standards appear. If more than one receiving module is used, data traffic can correspondingly be completely acquired simultaneously on several WLAN radio channels. If more channels have to be examined than there are radio modules, the independent WLAN measuring probe can autonomously change the measured radio channel periodically. The sequence control takes into account the number of radio modules, their respective technical possibilities and the current situation at the measurement location (for example, less frequent measurements on channels that are obviously unused). The antennas required for the measurement can be integrated in the housing of the independent WLAN measuring probe. Alternatively, external antennas can be used via appropriate connections.

The specific embodiment of the independent WLAN measuring probe can also record spectrum usage measurement data in parallel to the recording of WLAN data traffic, which allows radio systems that do not operate according to the WLAN standard and interferences that do not originate from a communication system (e.g. microwave ovens) to be detected.

The specific embodiment of the independent WLAN measuring probe works autonomously apart from the power supply, i.e. the measurement is carried out automatically and without user intervention. A connection to a control system, for example, is not necessary during the measurement. A focus for the measurement can be defined in advance. A readjustment of measuring parameters during the measurement is not possible. Therefore, the special embodiment of the independent WLAN measuring probe may have to make its own adjustments if necessary. The independent function allows a large freedom in the choice of the location of installation, so that the independent WLAN measuring probe can always be installed at the location where the respective problems occur, if possible. It can also be used in locations where the permanent presence of an operator is problematic, as well as on moving machines or vehicles. Since no operator is required, personnel costs can be possibly saved.

The independent WLAN measuring probe in all its embodiments is independent of existing network installations and represents a system that is technically completely detached from the existing network infrastructure. This makes it possible to diagnose errors immanent to the network system.

The independent WLAN measuring probe is more advantageous—but not necessarily robust, i.e. weatherproof, vibration-proof and temperature-resistant (temperature range common in industrial environments). If the WLAN measuring probe is not completely energy independent, a power supply can be flexibly arranged so that the independent WLAN measuring probe can be operated on the power grid or on on-board power supplies. If the independent WLAN measuring probe is energy independent for bridging periods, it is insensitive to spontaneous loss of power supply. Shorter interruptions are then intercepted by the battery. In this case, the measuring probe or comprised control unit can be additionally configured to automatically and controlled shutdown the independent WLAN measuring probe during longer interruptions, so that defects in the measuring data memory are prevented and the reliable documentation of already measured measuring periods is ensured.

The independent WLAN measuring probe has an internal memory large enough to store measurement data for longer periods of time (e.g. several weeks). If the memory of the independent WLAN measuring probe is exhausted, the independent WLAN measuring probe can depending on the configuration stop the recording or overwrite the respective oldest measuring data, so that a ring buffer similar to that in a voice recorder on board of aircrafts is created.

The principle of the WLAN measuring probe allows it to be used in data protection-sensitive areas. The measurement data are not transmitted outside the independent WLAN measurement probe during the measurement. They can already be encrypted during recording, so that during or after the measurement no data can fall into the unauthorized hands of third parties, even if the independent WLAN measuring probe is lost. Also, data, especially but not only useful data of the data package, can already be pseudonymized, anonymized or partially removed (“blackened”) already during the recording.

Advantageously, but not necessarily, the independent WLAN measuring probe has a real-time clock and a receiver for satellite navigation systems (GPS, GALILEO, GLONASS, etc.), which allows georeferencing of the measurement data for mobile outdoor applications and additionally a network-independent time alignment.

The independent WLAN measuring probe is particularly easy to use and requires no expert knowledge in installation. Depending on the embodiment, the independent WLAN measuring probe only requires a power supply. An integration into existing networks is not necessary. No feelers or other operating elements are necessary for initial operation of the externally powered independent WLAN measuring probe and therefore preferably also not present. To start the measurement, it is sufficient to connect the device to the power supply and to end the measurement, it is sufficient to disconnect the device from the power supply. A single control element is sufficient for initial operation and decommissioning of a permanently energy independent WLAN measuring probe. The independent WLAN measuring probe can be more advantageous—but not necessarily have a status display, for example a multicolored LED or several LEDs, through which even inexperienced users can easily recognize whether the recording is working correctly and whether the internal memory is exhausted.

These properties allow special application scenarios. For example, the independent WLAN measuring probe can be sent as a parcel and put into operation on site by an inexperienced user. At the end of the measurement, the independent WLAN measuring probe can also be returned as a parcel. An expert can then read and evaluate the measurement data from the independent WLAN measurement probe.

Optionally, the independent WLAN measuring probe comprises a port for an external storage unit, for example a USB port or a port for connecting a wired network connection to a mass storage device, or a slot for holding a memory card, for example an SD card or microSD card. Then the user can connect an external memory module on site to the independent WLAN measuring probe, to which all measurement data accumulated up to that point are automatically transferred and then deleted from the memory of the independent WLAN measuring probe if necessary.

The independent WLAN measuring probe can optionally be equipped with a maintenance interface (for example via mobile radio, other radio system, WLAN), which allows control of the recording during the measurement.

In addition to purely passive measurement, the independent WLAN measuring probe can also be configured to perform active tests to assess the usability and functionality of WLAN networks. For this purpose, the independent WLAN measuring probe can regularly, for example periodically, log into existing WLAN networks, check the accessibility of certain remote stations and test the quality of services. The results are protocoled in the independent WLAN measuring probe and thus allow a later evaluation over the course of time.

Through the active tests, the state of the network can also be assessed in situations in which this is not possible through the observation by other devices, for example in the absence of other devices.

1. A device for generating a data base suitable for identifying problems in a wireless network, wherein the device comprises at least one receiver unit for receiving data packets via a radio channel of the wireless network and a memory unit for storing data from received data packets, wherein the device further comprises a control unit configured to store control data contained at least in flap received data packets in the memory unit, wherein the control unit is configured to select data packets received independently from the receiver unit for storage in the database.

2. The device of claim 1, wherein the wireless network comprises at least two radio channels and the control unit is configured to control the receiver unit so that it receives data packets in chronological order via the at least two radio channels.

3. The device according to claim 1, wherein only a part of control data of a subsequently received data packet is stored which is not correlated with control data of a previously received data packet.

4. The device according to claim 1, wherein the device further comprises a transmitting unit for transmitting test data packets via one radio channel of the wireless network and the control unit is configured to control the transmitting unit such that these transmit test data packets at times determined by the control unit depending on at least one selected from a load of the radio channel and a disturbance of the radio channel by test data packets.

5. The device according to claim 1, wherein the control unit and the receiver unit are integrated in a housing and the device further comprises at least one radio antenna also integrated in the housing and/or at least one connection on the housing for connecting an external radio antenna.

6. The device according to claim 1, wherein the device further comprises a unit for acquiring measurement data for use of the frequency spectrum, the measurement data being stored.

7. The device according to claim 6, wherein the measurement data are acquired with different time resolutions and/or with different frequency resolutions and/or with different recording delays and/or with measuring principles and the control unit is configured to control the measurement data acquisition in such a way that the measurement data are synchronized with one another and/or with the control data.

8. The device according of claim 7, wherein the control unit is configured to mask artifacts in the measurement data generated by the device and/or by one or more further devices.

9. The device according to claim 1, wherein the device further comprises at least one of the following components:
a real-time clock;
a satellite-based positioning system;
a secondary battery;
a power connection and/or
an external memory port for connecting an external memory unit.

10. A method for identifying only temporary, sporadic and/or non-reproducible occurring problems in a wireless network, the method comprising:
sending a device from a service provider to a user, wherein the device comprises at least one receiver unit configured for receiving data packets via a radio channel of the wireless network, a memory unit configured for storing data from received data packets, and a control unit configured to store control data contained at least in the received data packets in the memory unit, wherein the control unit is configured to select data packets received independently, from the receiver unit for storage in the database;
connecting the device at a user-determined measurement location and at a user-determined start time by the user to a power supply;
disconnecting the device at a user-determined end time, which is around a minimum measurement period after the start time, from the power supply by the user;
sending the measuring probe back to the service provider; and
reading and evaluating the data stored in the device.

11. The device according to claim 1, wherein the data packets are selected to be received by the control unit from tell receiver unit in an automated and dynamically adaptive manner.

12. The method according to claim 10, further comprising:
independently selecting, in an automated and dynamically adaptive manner, the data packets to be received at the control unit from the receiver unit.
